(19) United States
(12) Patent Application Publication
(10) Pub. No.: US 2012/0278252 A1
(43) Pub. Date: Nov. 1, 2012

(54) SYSTEM AND METHOD FOR RECOMMENDING ESTABLISHMENTS AND ITEMS BASED ON CONSUMPTION HISTORY OF SIMILAR CONSUMERS

(76) Inventor: Shaun B. Sethna, Houston, TX (US)

(21) Appl. No.: 13/095,355

(22) Filed: Apr. 27, 2011

(51) Int. Cl. G06Q 30/00

(52) U.S. Cl. 705/347

(57) ABSTRACT

Systems and methods for recommending establishments and/or items from establishments based on a consumption history of similar consumers are provided. Ratings data can be received from each of a plurality of consumers via an automated process. For example, consumers can take a picture of a receipt after patronizing a restaurant or other establishment. Optical character recognition can then be performed on the receipt to identify, for example, the establishment patronized, items ordered, and the price of each item ordered. The ratings data obtained by the automated process can then be associated with each consumer to create a ratings history. Establishment and/or item recommendations then can be provided to consumers based on their history and that of consumers with similar histories.

### TECHNICAL FIELD

The invention relates to systems and methods for recommending restaurants (or other establishments) to consumers, and items to consume at those establishments. More particularly, the invention relates to receiving the consumption history of a given consumer and a plurality of consumers, and recommending establishments and items to the consumer based on establishments frequented and items consumed by consumers with a consumption history similar to that of the given consumer.

### BACKGROUND

In most industries, consumers have countless choices in selecting a given establishment to patronize and items to consumer while at the establishment. For example, in most cities or other geographical areas, consumers have countless choices of restaurants when they desire to eat a meal. Moreover, in many larger cities, there can be a massive number of restaurants within each restaurant category or cuisine. Additionally, at a given restaurant—particularly a restaurant that the consumer has never or rarely patronized previously—the consumer may encounter a menu containing many food items that the consumer may consider ordering. With all of these choices, consumers can often use help and additional information in selecting a restaurant, and what to order at a particular restaurant.

To address these needs, various conventional methods exist for providing restaurant recommendations to consumers. For example, traditional media as well as Internet websites exist for the purpose of providing reviews of restaurants, in addition to providing more objective descriptive information (e.g., average prices, type of cuisine) about the restaurant. Often times, consumers can provide their comments and information for a given restaurant in addition to a professional reviewer, thereby providing additional opinions for consumers.

One problem that arises with relying on reviews to select a restaurant is that it is quite likely that a given consumer does not have the same preferences as the reviewer, thereby reducing the value of the review. To address this limitation, it may be possible to use systems that attempt to analyze the consumption history of many consumers, and give recommendations to consumers based on the favorite restaurants of consumers with a similar consumption histories. Such systems are common in certain industries other than restaurants, as online bookstores and movie rental sites often recommend products to consumers based on their past orders and those of others with similar order histories.

Although attempts may have been made to develop systems for recommending restaurants and food items to consumers based on their order histories and those of other consumers with similar order histories, such attempts have not thus far been successful. Unlike with online shopping and movie rental sites, consumers' ordering history at restaurants are not generally automatically stored in any database that can be analyzed and culled to identify similar consumers. Instead, such attempts for the restaurant industry have required consumers to manually enter the restaurants at which they have dined, the items they consumed at the restaurants, the date they dined at the restaurant, the prices of meals at the restaurants, and the like. Because it is difficult for consumers to manually enter this information, it is nearly impossible for a system to capture order histories from enough consumers to be able to analyze the order history data thoroughly, and make effective recommendations based on that analysis. Accordingly,

Thus, a need in the art exists for a system and method for recommending restaurants or other similar establishments to potential consumers based on their order histories and the order histories of similar consumers that acquires the order histories from the consumers in a less cumbersome way than in conventional methods. A corresponding need in the art exists for recommending items at a given restaurant or establishment to consumers.

### SUMMARY OF THE INVENTION

The invention described herein can provide a system and method for recommending restaurants (or other similar establishments) and food items to potential consumers based on their order histories and the order histories of similar consumers that acquires the order histories from the consumers in a less cumbersome way than in conventional methods. Specifically, instead of requiring a consumer to manually input all of the relevant details of a given restaurant order (e.g., the name of the restaurant, the items ordered, the prices of the items), some or all of those details can be received from the consumer through an automated process. Such a system can reduce the amount of work the consumer would need to do to input the relevant details, thereby increasing the number of consumers who would be likely to regularly provide this information. By increasing this number of consumers, the number of order histories transmitted would also increase, and accordingly, the accuracy of any analysis and recommendations based on these order histories would greatly improve.

In one aspect, a method for providing establishment recommendations to a requesting consumer having a ratings history is provided. The method can include the steps of receiving through an automated process a ratings history from a plurality of consumers; and providing at least one of an establishment recommendation and an item recommendation to the requesting consumer based on the ratings history of the requesting consumer and the ratings history of similar consumers. Similar consumers comprise consumers in the plurality of consumers having a similar ratings history to the ratings history of the requesting consumer.

In another aspect, a method for receiving ratings data from a consumer is provided. The method can include the steps of receiving through an automated process ratings data from the consumer; identifying an establishment in the ratings data; and associating the establishment with the consumer.

In another aspect, a system for providing establishment recommendations to a requesting consumer having a ratings history is provided. The system can include an OCR module for performing optical character recognition on images of receipts received from a plurality of consumers and identifying ratings data associated with each consumer in the plurality of consumers; a database for storing a ratings history associated with each consumer, the ratings history comprising the identified ratings data associated with each consumer; and a similarity module in communication with the database for identifying similar consumers in the plurality of consumers. Similar consumers comprise consumers in the plurality of consumers having a similar ratings history to the ratings history of the requesting consumer.

These and other aspects, objects, and features of the present invention will become apparent from the following detailed description of the exemplary embodiments, read in conjunction with, and reference to, the accompanying drawings.

### BRIEF DESCRIPTION OF THE DRAWINGS

FIG. 1 is a diagram depicting components of a system for providing recommendations to consumers based on the order histories provided by the plurality of consumers through an automated process.

FIGS. 2A-2C are diagrams illustrating exemplary data structures used in storing order information received from consumers, according to an exemplary embodiment.

FIG. 3 is a diagram illustrating an exemplary flow of an exemplary user interface for the system, according to an exemplary embodiment.

FIG. 4 is a flow chart depicting a method for providing recommendations to consumers based on the order histories provided by the plurality of consumers through an automated process, according to an exemplary embodiment.

FIG. 5 is a flow chart depicting a method for creating a consumer's account, according to an exemplary embodiment.

FIG. 6 is a flow chart depicting a method for providing ratings data to a consumer, according to an exemplary embodiment.

FIG. 7 is a flow chart depicting a method for identifying an establishment to recommend to a consumer, according to an exemplary embodiment.

FIG. 8 is a flow chart depicting a method for identifying an item to recommend to a consumer, according to an exemplary embodiment.

FIG. 9 is a flow chart depicting a method for receiving ratings data from a consumer.

### DETAILED DESCRIPTION OF THE EXEMPLARY EMBODIMENTS

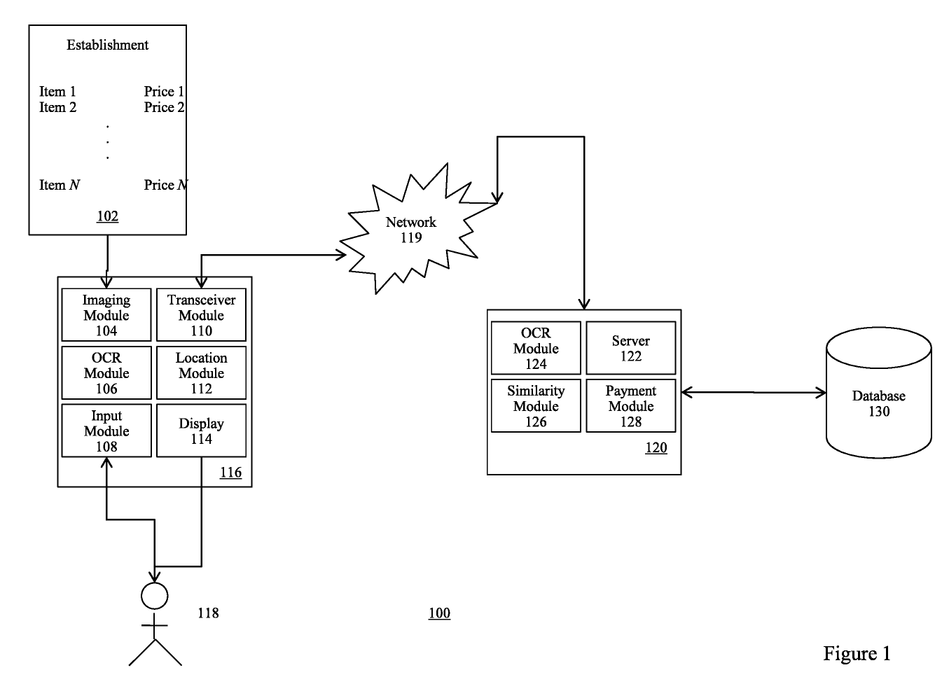

The invention enables a recommender to provide recommendations to consumers based on the order histories provided by the plurality of consumers through an automated process. A method and system for providing establishment and/or establishment item recommendations to consumers based on their order histories and the order histories of similar consumers will now be described with reference to FIGS. 1-9, which depict representative or illustrative embodiments of the invention.

FIG. 1 is a diagram depicting components of a system 100 for providing recommendations to consumers 118 based on the order histories provided by the plurality of consumers 118 through an automated process. The exemplary system 100 depicted in FIG. 1 includes a plurality of consumers 118 (shown as one representative consumer 118), a mobile device 116, a recommendation engine 120, and a database 130 or other data storage unit. In the exemplary system 100 depicted in FIG. 1, the consumers 118 can provide through an automated process order details from a restaurant to the recommendation engine 120 by capturing an image of a receipt 102 from the restaurant, using optical character recognition to identify the relevant information from the receipt 102, and communicating that information to the recommendation engine 120.

The consumers 118 can interact with the recommendation engine 120 via their mobile devices 116. As will be recognized by one of ordinary skill in the art having benefit of the present disclosure, the mobile device 116 can comprise any of several types of devices. In one embodiment, the mobile device 116 can comprise a mobile phone such as a smart phone. In other various embodiments, the mobile device 116 can comprise any other type of device suitable for use in communicating with the recommendation engine 120, such as a laptop computer, a cellular phone, or a camera capable of communicating with the recommendation engine 120.

Regardless of the form of the mobile device 116, the exemplary mobile device 116 can include various components for assisting consumers 118 in interacting with the recommendation engine 120. For example, the mobile device 116 can include various standard input and output components, such as an input module 108 for receiving input from the consumer 118 and a display 114 for displaying information to the consumer 118. In other embodiments, the mobile device 116 also can include a speaker or other component for providing audible information to the consumer 118.

The mobile device 116 also can include a variety of components for processing the receipt 102, as described above. For example, the mobile device 116 can include an imaging module 104, such as a camera, for capturing an image of the receipt 102. The mobile device 116 also can include an OCR (optical character recognition) module 106 for identifying text on the receipt 102. The OCR module 106 can comprise a processor with the necessary software or instructions for identifying text contained the the image of the receipt 102. This text can include order information for a given consumer's 118 meal at a restaurant, such as the name of the restaurant, the items ordered, the prices of each item, and the date.

The exemplary mobile device 116 also includes additional components, such as a location module 112 (e.g., a GPS module) for identifying the location of the mobile device 116, and a transceiver module 110 for communicating with the recommendation engine 120 via a network 119. In various exemplary embodiments, the transceiver can be any input and output mechcanism for communicating via WiFi, WiMAX, CDMA, GSM, or other mechanisms for communicating via a network 119 such as the Internet.

The recommendation engine 120 depicted in FIG. 1 receives and transmits information via the network 119 to the mobile devices 116 of the consumers 118. In an exemplary embodiment, the recommendation engine 120 can use the server 122 (such as a web server) for the receiving order information from the mobile devices 116 and providing restaurant recommendations to the mobile devices 116.

The recommendation engine 120 also includes a variety of components used in processing the order information received from the mobile devices 116. For example, the recommendation engine 120 can include an OCR module 124, similar to the OCR module 106 on the mobile device 116. In one embodiment, the recommendation engine 120 can include an OCR module 124 instead of the mobile device 116, as some mobile devices 116 may lack the processing capacity to perform optical character recognition. In other embodiments, even where mobile devices 116 include an OCR module 106 as described above, the recommendation engine 120 can include an OCR module 124 as well, so that the system 100 has the option of performing OCR on the mobile device 116 or at the recommendation engine 120.

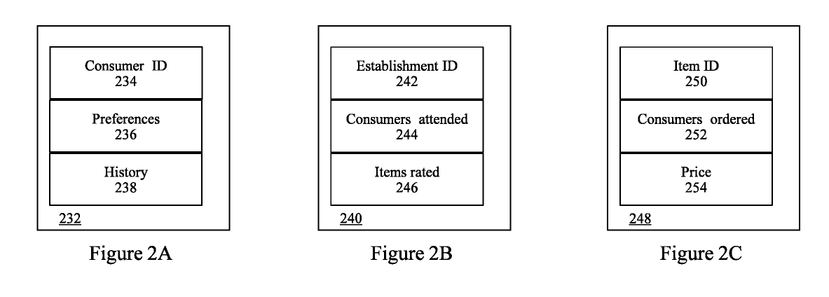

The exemplary recommendation engine 120 also includes a similarity module 126 for analyzing all of the order information received from consumers 118 (which can be stored in the database 130 in communication with the recommendation engine 120). The similarity module 126 can analyze the order information to be able to identify consumers 118 with similar ordering history to a given consumer 118, and then identify restaurants and/or restaurant items that the given consumer 118 is likely to like based on that analysis. The similarity module 126 then can communicate the identified restaurants and/or items to the given consumer 118 via the server 122, the network 119, and the mobile device 116 of the consumer 118. Lastly, the exemplary recommendation engine 120 also can include a payment module 128, which can use information received from the receipt 102 and from the consumer 118 to be able to calculate the money due from each of the parties to the receipt 102, and provide those amounts to the consumer 118 as well. The elements described in FIG. 1 will be described in more detail below as they relate to the exemplary data structures, user interfaces, and methods illustrated in FIGS. 2-9.

FIGS. 2A-2C are diagrams illustrating exemplary data structures used in storing order information received from consumers 118, according to an exemplary embodiment. FIG. 2A is an exemplary consumer data structure 232 comprising information about a given consumer 118. The consumer data structure 232 can have a consumer ID 234, a unique identification number for identifying the consumer 118 in the recommendation engine 120. The consumer data structure 232 also can include preferences 236 associated with the consumer 118. These preferences 236 can include a variety of information, such as dietary restrictions, cuisine preferences, maximum prices that the consumer 118 is willing to pay for a meal, maximum distance that a consumer 118 is willing to travel for a meal, and a variety of other types of preferences that may be recognized by one of ordinary skill in the art having benefit of the present disclosure. Additionally, each consumer data structure 232 also can include a consumer history 238. The consumer history 238 can include order information (e.g., date, restaurant name, items ordered, prices of items, and a consumer rating for the restaurant and/or items ordered) for each time the consumer 118 has visited a restaurant and provided order information to the recommendation engine 120.

FIG. 2B is an exemplary establishment data structure 240 comprising information about a given restaurant or other establishment. The establishment data structure 240 can comprise an establishment ID 242, a unique identification number for identifying the establishment in the recommendation engine 120. The establishment data structure 240 also can include a consumers attended field 244, identifying all consumers 118 (such as by consumer ID) who have attended or provided order information for the establishment. Additionally, the establishment data structure 240 can include an items rated field 246, that identifies all items that have been rated (or at least ordered) by a consumer 118.

FIG. 2C is an exemplary item data structure 248 comprising information about a given food or other item ordered from an establishment. The item data structure 248 can comprise an item ID 250, a unique identification number for identifying the item in the recommendation engine 120. The item data structure 248 also can include a consumers ordered field 252, identifying all consumers 118 (such as by consumer ID) who have ordered or provided order information for the item. Additionally, the item data structure 248 can include a price field 254 that identifies the price of the item. Notably, in exemplary embodiments, each item may be considered unique to a given establishment. In other words, a cheeseburger at one establishment may have a different item ID 250 and corresponding information from a cheeseburger at a different establishment.

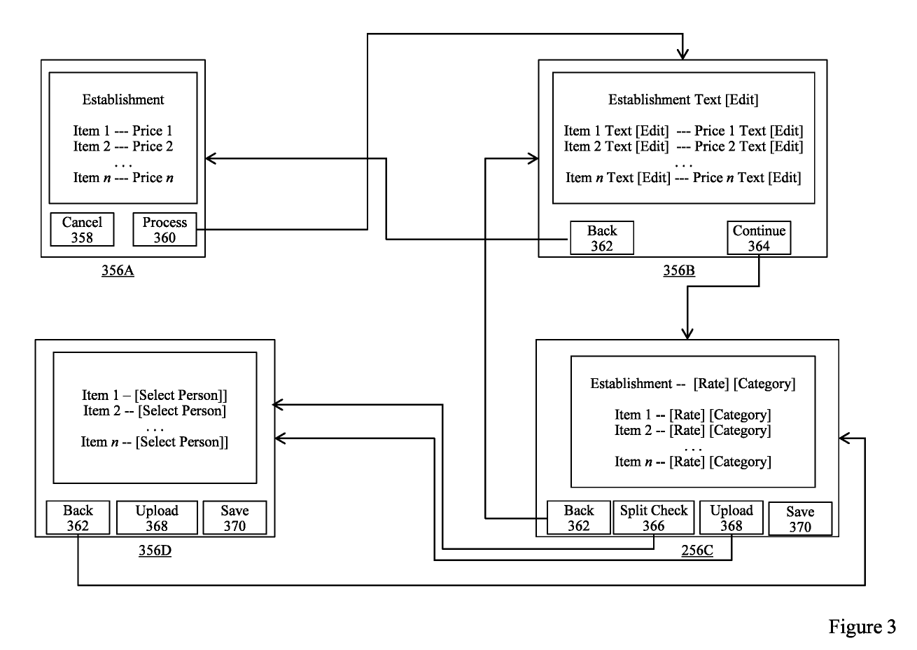

In certain embodiments as described herein, there may be significant overlap in the data stored in each of the foregoing exemplary data structures. For example, parts of the details of given order by a given consumer 118 at a given establishment can be stored in a consumer data structure 232 (as part of the history field) as well as an establishment data structure 240 (as part of the consumers attended field). As may be recognized by one of ordinary skill in the art having benefit of the present disclosure, such data need not be stored in multiple locations in the database 130. Rather, for example, the data can be stored at any suitable location and merely linked or associated with each of the exemplary data structures described herein. The elements described in FIG. 2 will be described in more detail below as they relate to the exemplary user interfaces and methods illustrated in FIGS. 3-9.

FIG. 3 is a diagram illustrating an exemplary flow of an exemplary user interface for the system 100, according to an exemplary embodiment. In one embodiment, such as that shown in FIG. 3, the user interface can comprise an application running on the mobile device 116. Stage A 356A of the application depicts one stage of an exemplary user interface, where the consumer 118 uses the mobile device 116 to capture an image of the receipt 102. For example, as shown in Stage A 356A, the consumer 118 can move the mobile device 116 and/or receipt 102 until the relevant portions of the receipt 102 are shown on the display 114 of the mobile device 116. The user interface at Stage A 356A can then display a cancel button 358 (for canceling the operation) and a process button 360 for capturing and processing the image shown, and continuing with the application. Once the consumer 118 presses the process button 360, the user interface can proceed to Stage B 356B.

In Stage B 356B, text corresponding to the image of the receipt 102 is shown. Each text field can include an edit button, which the consumer 118 can select. This may be useful if the optical character recognition used to convert the receipt 102 image to the text shown was imperfect, causing some of the text to be inaccurate. Selecting the edit button can enable the consumer 118 to use the input module 108 of the mobile device 116 to correct the text as needed. Once all of the text is correct, the consumer 118 can select the continue button 364 to proceed to Stage C 356C of the user interface. Alternatively, if the consumer 118 desires, the consumer 118 can select the back button 362 to return to Stage A 356A and retake the image of the receipt 102.

In Stage C 356C, the consumer 118 can use the user interface to rate the establishment and/or each of the items that were shown on the receipt 102. Various methods can be used to allow the consumer 118 to rate the establishments and/or items. For example, the consumer 118 could use the input module 108 of the mobile device 116 to enter a numeric rating, a number of stars, or a simple binary rating (e.g, good or bad). During Stage C 356C, the consumer 118 also can use the user interface to provide category information for the establishment or each of the items. Category information can include, for example, a cuisine for the restaurant, a course of meal for a food item, or other suitable types of categorical information. Stage C 356C of the user interface also includes a variety of buttons for controlling the flow of the user interface. For example, Stage C 356C includes a back button 362 for returning to Stage B 356B, and an upload button 368 for transmitting all collected information (i.e., order details including the ratings/category information) to the recommendation engine 120. Stage C 356C also can include a save button 370 for saving the information, ratings, and category information entered, for uploading or further editing at a later time. The save button 370 can be particularly useful if the consumer 118 seeks to provide additional ratings for the restaurant and/or items ordered at a later time. Lastly, Stage C 356C also includes a split check button 366, which launches Stage D 356D of the user interface.

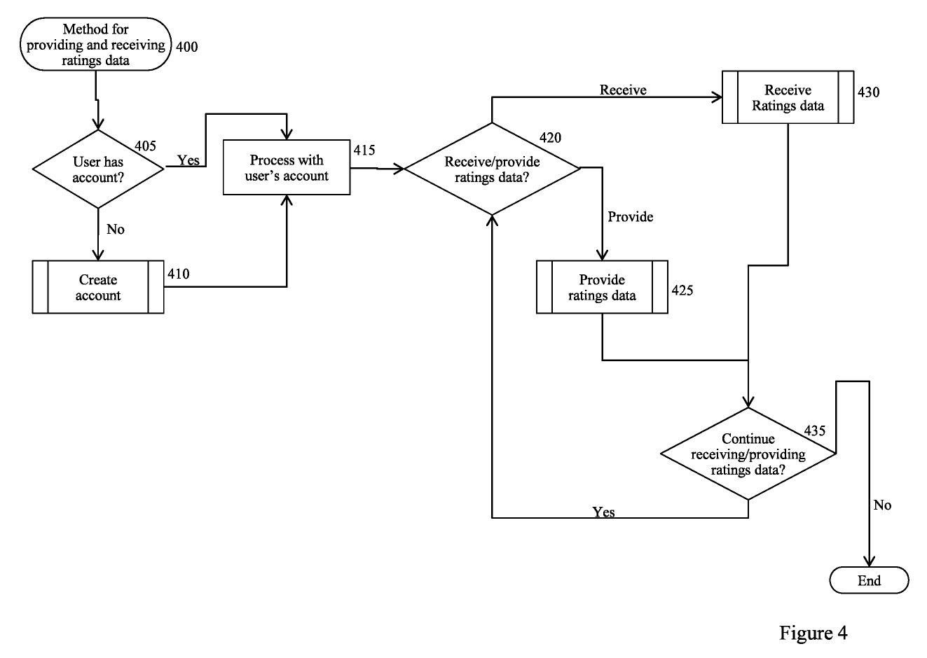

In Stage D 356D, the consumer 118 can use the user interface to split the receipt 102 among a plurality of parties sharing the cost of the meal ordered. As shown in Stage D 356D, in one embodiment, the items from the receipt 102 are all displayed, and the consumer 118 can select the person from the party who is to pay for the item. As may be recognized by one of ordinary skill in the art having benefit of the present disclosure, a variety of methods could be used for the consumer 118 to identify the person who is to pay for the item. For example, the consumer 118 could input names of the people who will be paying for the dinner, and then associate each item with the proper person, such as by selecting the name or dragging and dropping each item to the person's name. Alternatively, the consumer 118 may simply enter the number of people, and then associate each item with “Person 1,” “Person 2,” etc. After each item has been selected, the user interface then can display the amount that each person owes, based on the items they ate. Optionally, taxes (as displayed on the receipt 102) and gratuities (as displayed on the receipt 102 or calculated based on a selected percentage) also can be calculated and included in the display 114 to the consumer 118. Stage D 356D also includes the upload 368 and save buttons 370 described previously with reference to Stage C 356C. After the save or upload buttons 370, 368 are selected, the application can temporarily end until the consumer 118 decides to restart or resume the application. The elements described in FIG. 3 will be described in more detail below as they relate to the exemplary methods illustrated in FIGS. 4-9.

FIG. 4 is a flow chart depicting a method 400 for providing recommendations to consumers 118 based on the order histories provided by the plurality of consumers 118 through an automated process, according to an exemplary embodiment. In step 405, the method 400 determines whether the consumer 118 has an account with the recommendation engine 120. As described above with reference to FIG. 2A, in exemplary embodiments, a consumer's 118 account can include a consumer ID, a set of the consumer's 118 preferences, and an associated ordering and ratings history. If the consumer 118 has an account, the method 400 branches to step 415. Otherwise, the method branches to step 410.

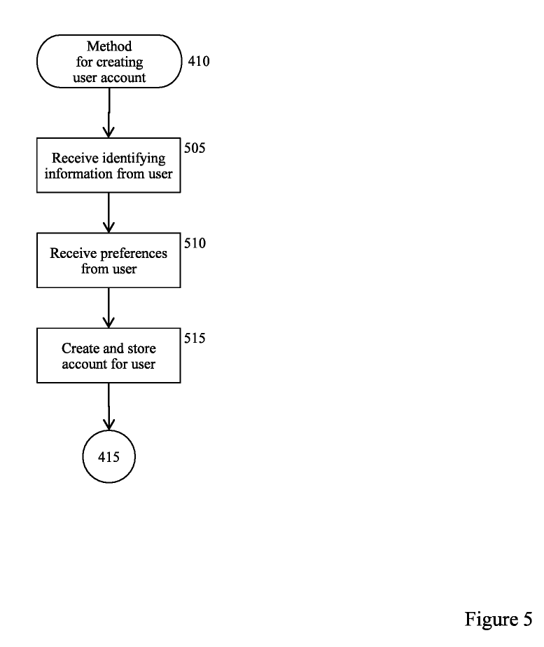

In step 410, a consumer 118 account is created. In an exemplary embodiment, the consumer 118 can be prompted to enter various information such as a user name and password, dietary restrictions, cuisine preferences, and the like, which can then be received by the recommendation engine 120. Step 410 will be described in more detail with reference to FIG. 5. After step 410, the method 400 proceeds to step 415.

In step 415, the recommendation engine 120 proceeds with the consumer's 118 account. In an exemplary embodiment, the recommendation engine 120 can proceed with the consumer's 118 account after receiving the consumer's 118 user name and password information.

In step 420, the method 400 determines whether the recommendation engine 120 will provide or receive ratings data. In an exemplary embodiment, this step 420 can be performed by prompting the consumer 118 to select whether the recommendation engine 120 should provide or receive ratings data. If the recommendation engine 120 will provide ratings data to the consumer 118, the method 400 branches to step 425. If the recommendation engine 120 will receive ratings data, the method 400 branches to step 430.

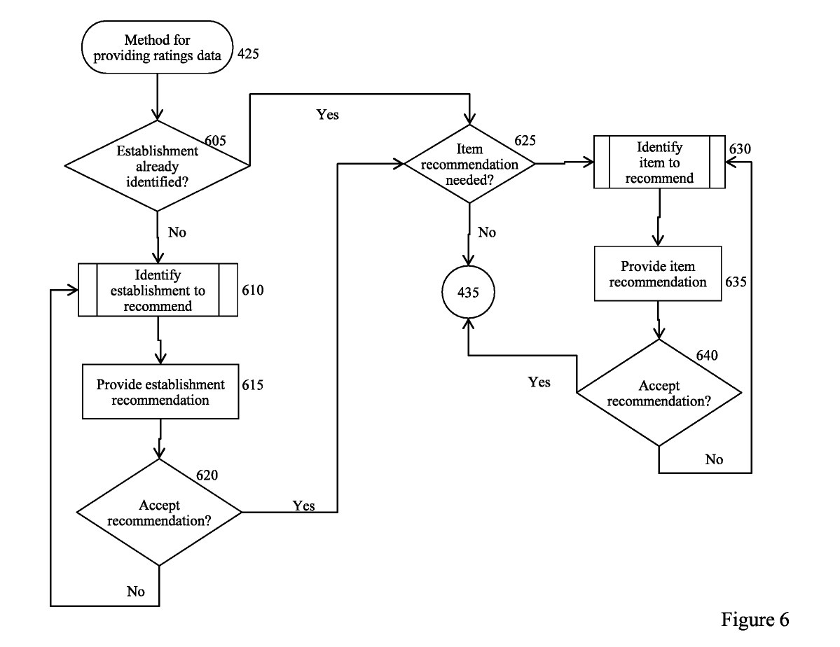

In step 425, the recommendation engine 120 provides ratings data to the consumer 118. In an exemplary embodiment, providing ratings data to the consumer 118 can include providing a restaurant (or other establishment) recommendation to the consumer 118 based on the consumer's 118 ordering history, location, and preferences. In another exemplary embodiment, providing ratings data to the consumer 118 can include providing a food (or other item) recommendation to the consumer 118 for a given establishment, based on the consumer's 118 ordering history and preferences. In other embodiments, providing ratings data can further include providing an estimated likelihood to the consumer 118 that the consumer 118 will like the recommended establishment and/or item. Step 425 will be described in more detail with reference to FIG. 6. After step 425, the method 400 proceeds to step 435.

In step 430, the recommendation engine 120 receives ratings data from the consumer 118. In exemplary embodiments, receiving ratings data from the consumer 118 can include receiving through an automated process the identity of an establishment (e.g., restaurant) patronized by the consumer 118, along with items ordered at the establishment. Receiving ratings data can further include receiving ratings from the consumer 118 for a given establishment and/or item.

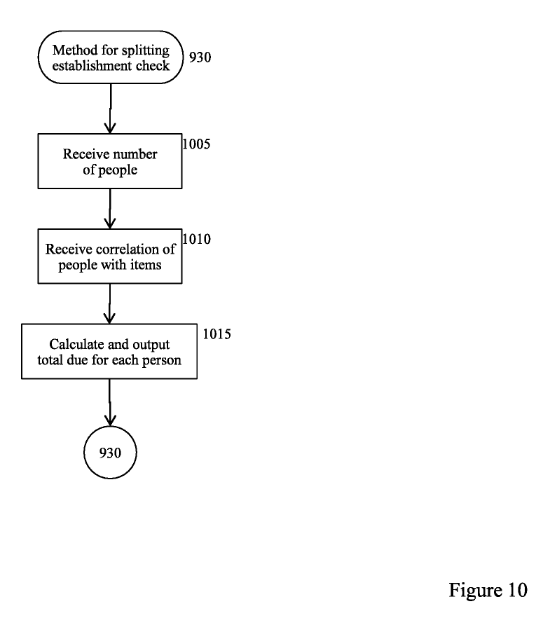

In various embodiments, various methods exist for receiving the ratings data from the consumer 118 through an automated process. For example, the consumer 118 can transmit an image of a receipt 102 identifying the establishment patronized and/or items ordered by the consumer 118. Such a method of Step 430 will be described in more detail with reference to FIG. 9. Other methods can include receiving such establishment and item information from a credit card company that the consumer 118 used to purchase the items, receiving an electronic copy of a receipt 102 provided to the consumer 118 by the establishment form, or receiving establishment information from the location module 112 (e.g. GPS) of the mobile device 116. Other automated processes, such as any process for identifying an establishment and/or item, and/or ratings therefor without requiring the consumer 118 to manually enter the name of the establishment and the items ordered, can be used. After step 430, the method 400 proceeds to step 435.

In step 435, the method 400 determines whether to continue providing and/or receiving ratings data to and/or from the consumer 118. Such a determination can be made by prompting the consumer 118 to indicate whether the consumer 118 desires to continue interacting with the recommendation engine 120. In other embodiments, such a determination can be inferred from the consumer's 118 use of the user interface. For example, if the consumer 118 closes the user interface, the recommendation engine 120 can interpret that as an indication that the consumer 118 does not desire to continue providing and/or receiving ratings data. If ratings data is to be continued to be provided and/or received to and/or from the consumer 118, then the method 400 returns to step 420. Otherwise, the method 400 ends.

FIG. 5 is a flow chart depicting a method 410 for creating a consumer's 118 account, according to an exemplary embodiment. In step 505, identifying information is received from the consumer 118. In an exemplary embodiment,the identifying information can include a user name and password for the consumer 118, an email address or other contact information for the consumer 118, and the like.

In step 510, consumer 118 preferences are received from the consumer 118. In various exemplary embodiments, a variety of consumer 118 preferences can be received from the consumer 118. For example, such consumer 118 preferences can include a distance the consumer 118 is generally willing to travel to an establishment, a price range that the consumer 118 is generally willing to pay at an establishment, cuisines generally favored or disfavored by the consumer 118, and food allergies. Other suitable consumer 118 preferences also can be used.

In step 515, an account for the consumer 118 is created and stored. In an exemplary embodiment, the information received in steps 505 and 510 can be associated with the newly-created consumer 118 account, and stored in the data storage unit. After step 515, the method 410 returns to step 415 of the method 400 described previously with reference to FIG. 4, where the recommendation engine 120 proceeds with the consumer's 118 newly-created account

FIG. 6 is a flow chart depicting a method 425 for providing ratings data to a consumer 118, according to an exemplary embodiment. In step 605, the method 425 determines whether an establishment has already been identified for the purpose of providing ratings data. In an exemplary embodiment, an establishment may have already been identified if the consumer 118 has specified a particular establishment that the consumer 118 is patronizing or planning on patronizing. In another exemplary embodiment, an establishment may have already been identified if a GPS or other locating means in the consumer's 118 mobile device 116 indicates that the consumer 118 is already at a particular establishment. In these cases, the consumer 118 may prefer to receive solely an item recommendation for the already-identified establishment. If an establishment has been identified, the method 425 branches to step 625. Otherwise, the method 425 branches to step 610.

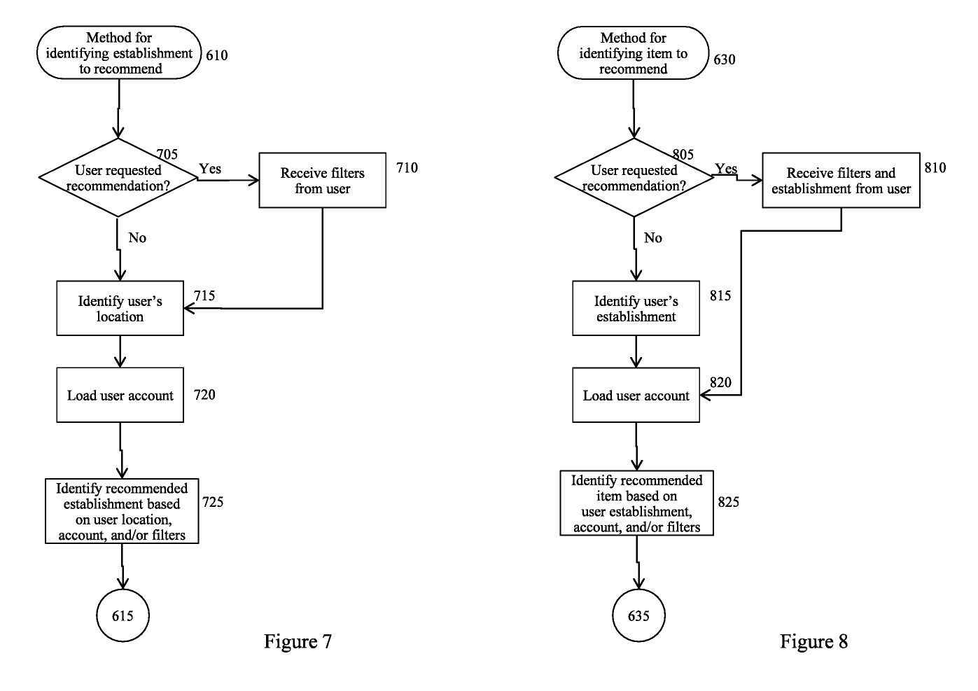

In step 610, an establishment to recommend to the consumer 118 is identified. In an exemplary embodiment, an establishment to recommend to the consumer 118 can be identified based on the consumer's 118 past ordering history and ratings history, as well as the consumer's 118 current (or specified) location, and the consumer's 118 preferences associated with the consumer's 118 account. Additionally, the recommendation can be further based on the ratings history of other consumers 118 having a similar ratings history as the given consumer 118. Step 610 will be described in more detail with reference to FIG. 7.

In step 615, the establishment identified in step 610 is provided to the consumer 118. In an exemplary embodiment, this can include identifying the name, address, and phone number of the establishment, as well as reviews of the establishment. In other embodiments, identifying the establishment can further include providing an estimated likelihood that the consumer 118 will enjoy the establishment, which can be based on the ratings history of the given consumer 118 and that of other consumers 118 with a similar ratings history as the given consumer 118.

In step 620, the method 425 determines whether to accept the recommendation provided in step 615. In an exemplary embodiment, this can be determined by prompting the consumer 118 to accept the recommendation or request a new recommendation. If the recommendation is accepted, the method 425 branches to step 625. Otherwise, the method 425 returns to step 610, where another establishment to recommend to the consumer 118 is identified.

In step 625, the method 425 determines whether an item recommendation is needed. In certain embodiments, this can be determined by prompting the consumer 118 to select whether the consumer 118 desires an item recommendation, rather than solely an establishment recommendation. If an item recommendation is needed, the method 425 branches to step 630. If an item recommendation is not needed, then the method 425 returns to step 430 of the method 400 previously described with reference to FIG. 4, where the recommendation engine 120 receives ratings data from the consumer 118.

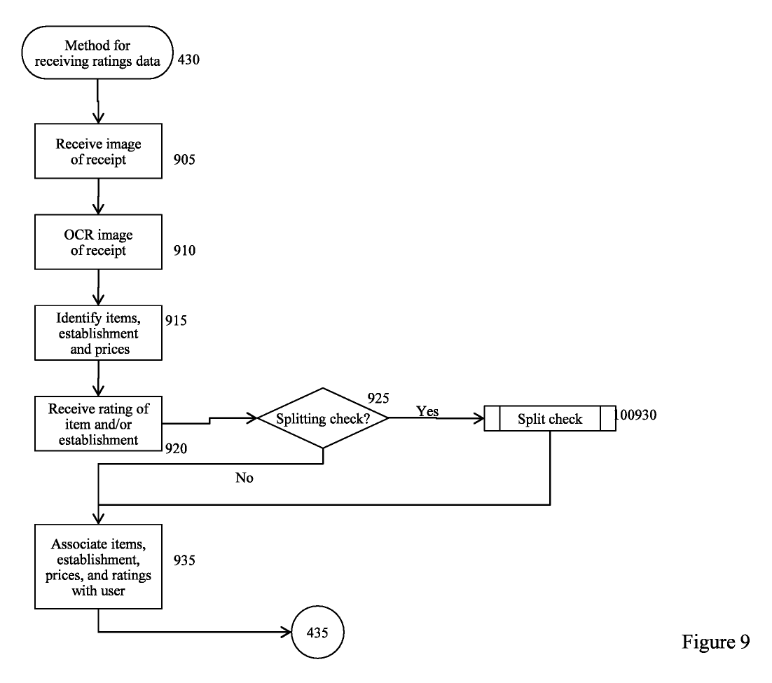

In step 630, an item to recommend to the consumer 118 is identified. As with the establishment recommendation described in Step 610, in an exemplary embodiment, an item to recommend to the consumer 118 can be identified based on the consumer's 118 past ordering history and ratings history, as well as the consumer's 118 current (or specified) establishment, and the consumer's 118 preferences associated with the consumer's 118 account. Additionally, the recommendation can be further based on the ratings history of other consumers 118 having a similar ratings history as the given consumer 118. Step 630 will be described in more detail with reference to FIG. 8.

In step 635, the item identified in step 630 is provided to the consumer 118. This step 635 can include identifying the name and price of the recommended item. In certain embodiments, this step 635 can further include providing an estimated likelihood that the consumer 118 will enjoy the recommended item, which can be based on the consumer's 118 ratings history as well as the ratings history of other consumers 118 with a ratings history similar to that of the given consumer 118.

In step 640, the method 425 determines whether to accept the recommendation provided in step 635. In an exemplary embodiment, this can be determined by prompting the consumer 118 to accept the recommendation or request a new recommendation. If the recommendation is accepted, the method 425 returns to step 430 of the method 400 previously described with reference to FIG. 4, where the recommendation engine 120 receives ratings data from the consumer 118. Otherwise, the method 425 returns to step 630, where another item to recommend to the consumer 118 is identified.

FIG. 7 is a flow chart depicting a method 610 for identifying an establishment to recommend to a consumer 118, according to an exemplary embodiment. In step 705, the method 610 determines whether the consumer 118 requested an establishment recommendation. In an exemplary embodiment, consumer 118 can request an establishment recommendation by using the user interface, such as by selecting an option to receive an establishment recommendation. Conversely, the consumer 118 may not request a recommendation. For example, in certain embodiments, the consumer 118 may not explicitly request an establishment recommendation, but one or more may be automatically provided to the consumer 118, such as at a particular meal time or other time when a consumer 118 is likely to patronize an establishment, and/or when the consumer 118 is relatively proximate (e.g., within a given distance) to the establishments being considered for a recommendation. If the consumer 118 requested a recommendation, the method 610 branches to step 710. Otherwise, the method 610 branches to step 715.

In step 710, the recommendation engine 120 receives filters associated with the consumer 118. In various exemplary embodiments, the filters received can include a variety of characteristics for an establishment that the consumer 118 wishes to patronize. Example filters include a maximum distance that the consumer 118 is willing to travel, an estimated wait time for service at the establishment, a type of cuisine, a price range, and the like. After step 710, the method 610 proceeds to step 715.

In step 715, the consumer's 118 location is identified. In an exemplary embodiment, as discussed previously, the consumer's 118 location can be identified using the location module 112, such as a GPS module. Alternatively, the consumer's 118 location can be identified by tracking cellular antennae used by the consumer's 118 mobile device 116. In another embodiment, the consumer 118 can manually provide the location.

In step 720, the consumer's 118 account is loaded. In an exemplary embodiment, the consumer's 118 account can include the type of information discussed above with reference to FIG. 2A, such as the consumer's 118 preferences and ordering history. Various components of ordering history can be loaded and considered, such as the dates of each order, the establishments patronized by the consumer 118, the items ordered by the consumer 118 at each establishment, the prices paid for the items, any ratings given by the consumer 118 for each of the patronized establishments or ordered items, and the like.

In step 725, an establishment to recommend is identified, based on the consumer's 118 filters, location, and/or account. In exemplary embodiments, identifying the establishment to recommend to the consumer 118 can include analyzing the order history of the consumer 118, comparing the order history of the consumer 118 to order histories of a plurality of other consumers 118 stored in the database 130, and identifying establishments patronized by other consumers 118 with order histories similar to the order history of the given consumer 118. These steps can be performed by the similarity module 126 of the recommendation engine 120, which communicates with the server 122 and the database 130. Identifying other consumers 118 with order histories similar to the order history of the given consumer 118 can be accomplished by various methods, such as using clustering algorithms (e.g., hierarchical clustering, agglomerative clustering, concept clustering, k-means clustering, fuzzy c-means clustering, spectral clustering). Alternatively, so-called brute force algorithms can be used to identify similar order histories by examining each order history stored in the database 130. Other suitable algorithms, as may be recognized by one of ordinary skill in the art having benefit of the present disclosure, can additionally be used.

Regardless of the particular algorithms selected for identifying similar order histories among consumers 118, the similarities of order histories among consumers 118 can be identified along a variety of parameters. For example, when identifying similarities, factors such as the dates and times of each order, the establishments patronized by the consumer 118, the items ordered by the consumer 118 at each establishment, the prices paid for the items, any ratings given by the consumer 118 for each of the patronized establishments or ordered items, and the like, all can be considered. Other suitable factors, as may be recognized by one of ordinary skill in the art having benefit of the present disclosure, can also be used. Moreover, regardless of the factors considered in identifying similarities, weighting can be assigned to each of the factors, so that certain factors (e.g., establishments patronized and ratings given) may be weighted more heavily in identifying similarities, and other factors (e.g., the times of day of each order) may be weighted less. Additionally, more recent order histories can be weighted more heavily than older order histories, in an exemplary embodiment.

In certain embodiments, analysis to identify similarities among the order histories of consumers 118 can be performed continuously, periodically, or at random times, and not necessarily during a time when a consumer 118 requests an establishment recommendation. For example, in certain embodiments, daily analysis of the order histories stored in the database 130 can be performed and clusters among similar order histories can be identified so that establishment recommendations can be readily and relatively quickly identified once a consumer 118 requests a recommendation. Additionally, in exemplary embodiments, some or all of the results of the analysis to identify similarities among the order histories of consumers 118 can be communicated to the consumers 118

After step 725, the method 610 returns to step 615 of the method 425 previously described with reference to FIG. 6, where the identified establishment is provided to the consumer 118.

FIG. 8 is a flow chart depicting a method 630 for identifying an item to recommend to a consumer 118, according to an exemplary embodiment. In step 805, the method 630 determines whether the consumer 118 requested an item recommendation. In an exemplary embodiment, a consumer 118 can request an item recommendation by using the user interface, such as by selecting an option to receive an item recommendation. Conversely, the consumer 118 may not request a recommendation for a particular item, because, for example, the consumer 118 may already know which item the consumer 118 desires to order. If the consumer 118 requested a recommendation, the method 630 branches to step 810. Otherwise, the method 630 branches to step 815.

In step 810, the recommendation engine 120 receives filters and the establishment associated the consumer 118. In various exemplary embodiments, the filters received can include a variety of characteristics for an item that the consumer 118 wishes to order. Example filters include a maximum price, a dietary restriction or preference, a course of a meal (e.g., an entree, a dessert, etc.). After step 810, the method 630 proceeds to step 820.

In step 815, the establishment to be associated with the consumer's 118 item recommendation is identified. In an exemplary embodiment, the establishment identified in this step 815 is the same establishment identified in step 610 referenced in FIG. 6.

In step 820, the consumer's 118 account is loaded. In an exemplary embodiment, the consumer's 118 account can include the type of information discussed above with reference to FIG. 2A, such as the consumer's 118 preferences, dietary restrictions, and ordering history. Various components of ordering history can be loaded and considered, such as the establishments patronized by the consumer 118, items ordered by the consumer 118 at various establishments, prices paid for the items, and the like.

In step 825, an item to recommend is identified, based on the establishment and the consumer's 118 location and/or account. In exemplary embodiments, identifying the item to recommend to the consumer 118 can include analyzing the order history of the consumer 118, comparing the order history of the consumer 118 to order histories of a plurality of other consumers 118 stored in the database 130, and identifying establishments patronized and/or items ordered by other consumers 118 with order histories similar to the order history of the given consumer 118. Identifying other consumers 118 with order histories similar to the order history of the given consumer 118 can be accomplished by various methods, such as those described above with reference to step 725 of FIG. 7. After step 825, the method 630 returns to step 635 of the method 425 previously described with reference to FIG. 6.

FIG. 9 is a flow chart depicting a method 430 for receiving ratings data from a consumer 118. In step 905, an image of the receipt 102 is received. In an exemplary embodiment, the image can be received by the consumer 118 using the camera or other imaging module 104 of the mobile device 116 to capture an image of the receipt 102. In a particular embodiment, the image can be captured by providing an interface similar to that described above with respect to FIG. 3.

In one embodiment, the image of the receipt 102 is immediately transferred from the mobile device 116 to the recommendation engine 120 for further processing and analysis. In another embodiment, the image of the receipt 102 remains on the mobile device 116 for further processing and analysis at this time.

In step 910, optical character recognition is performed on the image of the receipt 102. Any suitable optical character recognition process or algorithm can be performed on the image of the receipt 102. In an exemplary embodiment, the optical character recognition can begin being performed upon the consumer's 118 selection of the “Process” link, previously discussed with reference to FIG. 3, once the receipt 102 is within the capture area of the imaging module 104 of the mobile device 116. In certain embodiments, the optical character recognition is performed by the OCR module 106 of the mobile device 116. In other embodiments, the optical character recognition is performed by the OCR module 124 of the recommendation engine 120. In yet another embodiment, the decision to perform the optical character recognition on the mobile device 116 or the recommendation engine 120 can be made based on a variety of factors. For example, if the mobile device 116 has an active connection to the network 119, whether by WiFi, WiMAX, CDMA, GSM, or the like, then the image of the receipt 102 may be transmitted from mobile device 116 to the recommendation engine 120, where the optical character recognition is performed. Conversely, if the mobile device 116 does not have an active connection to the network 119 when the optical character recognition is to be performed, the optical character recognition can be performed by the OCR module 106 of the mobile device 116.

In step 915, the items, establishment, and prices specified on the receipt 102 are identified. In an exemplary embodiment, the OCR module 106, 124 or other processor in the server 122 or mobile device 116 can analyze the results of the optical character recognition to identify the items, establishment, and prices specified on the receipt 102. A variety of factors can be considered in identifying these features of the receipt 102. For example, numerical entries on the right side of the receipt 102 can be identified as prices, and textual entries on the left side of the receipt 102 lining up with the prices can be identified as items. Text at the top of the receipt 102 can be identified as the establishment. In certain embodiments, the text identified at the top of the receipt 102 can be cross-referenced with data received from the location module 112 to confirm that the establishment has been properly identified.

In certain embodiments, after preliminarily identifying the items, establishment, and prices specified on the receipt 102, these identified features can be presented to the consumer 118 for confirmation and/or editing. For example, as shown in FIG. 3, each of the items, establishment, and prices displayed in text format can include an “Edit” link wherein the consumer 118 can edit these values or fields as needed.

In step 920, ratings of the item and/or establishment identified in step 915 are received. In an exemplary embodiment, an interface such as that shown in FIG. 3 can be used to receive item and/or establishment ratings from the consumer 118. Regardless of the interface provided, the ratings received can take any number of forms. For example, the user interface can prompt the consumer 118 to give a binary (e.g., “Thumbs up” or “Thumbs down”) rating as to the establishment and/or items. Alternatively, a scale (e.g., 1-5 stars, poor through excellent) rating can be used. These ratings then can be transmitted to the recommendation engine 120 via the network 119. Alternatively, the ratings can be transmitted at a later time if, for example, the mobile device 116 lacks an active network 119 connection, the ratings can be stored on the mobile device 116 itself and uploaded to the recommendation engine 120 after connecting to the network 119.

In step 925, the method 430 determines whether to split the check among the parties dining In an exemplary embodiment, the determination of whether to split the check can be made based on whether the consumer 118 selects an option in the user interface to split the check, as discussed above with reference to FIG. 3. If the check is to be split, the method 430 branches to step 930. Otherwise, the method 430 branches to step 935.

In step 930, the check is split among the parties dining. In an exemplary embodiment, splitting the check among the parties can include receiving an indication of which items were ordered by which parties, and then calculating a total for each party based on the items ordered. Step 930 will be described in more detail with reference to FIG. 10. After step 930, the method 430 proceeds to step 935.

In step 935, the ratings received in step 930 and the items, establishment, and prices identified in step 915 are associated with the consumer 118. In an exemplary embodiment, the ratings, items, establishment, and/or prices all can be associated with the consumer's 118 account and added to the consumer's history, as described above with reference to FIG. 3. This data can be transferred to the recommendation engine 120 and then stored in the database 130.

After step 935, the method 430 returns to step 435 of the method 400 previously described with reference to FIG. 4.

FIG. 10 is a flow chart depicting a method 930 for splitting a check among parties dining at an establishment. In step 1005, the number of people or parties splitting the check is received. In an exemplary embodiment, the consumer 118 can enter the number of people or parties splitting the check. In another embodiment, the consumer 118 can additionally enter names for the people or parties splitting the check. Some or all of the steps relating to the method 930 for splitting the check can be performed by the payment module 128, as previously described with reference to FIG. 1.

In step 1010, a correlation of the items on the check with the parties splitting the check is received. In an exemplary embodiment, the mobile device 116 can display the items on the check and provide an interface to the consumer 118 for associating each of the items with a person or party. For example, the mobile device 116 can display the names of the parties (or, if names were not entered in step 1005, an identifier such as “Person 1”, “Person 2”, etc.) in one column, and the items ordered in another column, and allow the consumer 118 to drag and drop each item to a party identifier. Alternatively, the items can all be displayed in one column, and a selection interface such as a drop-down menu containing the list of party identifiers can be associated with each of the items, allowing the consumer 118 to select the party identifier associated with each item. In an exemplary embodiment, regardless of the interface provided for associating parties with items, items can be associated with multiple parties in case multiple parties are splitting the cost for certain items.

In step 1015, the total due for each party is calculated and outputted. In an exemplary embodiment, after each item is associated with at least one person or party, the total cost of each person or party's items is added together and displayed on the mobile device 116. The total cost displayed can include the raw total, the raw total plus tax, or the raw total plus tip and tax, in various embodiments.

In certain embodiments, one person can pay the establishment for the entire check, and then the payment module 128 can send electronic invoices to the remaining parties for their share of the bill. A payment processor, such as PAYPAL or GOOGLE CHECKOUT, can be used to facilitate the transmission of invoices.

After step 1015, the method 925 returns to step 930 of the method 430 previously described with reference to FIG. 9.

The exemplary methods and steps described in the embodiments presented previously are illustrative, and, in alternative embodiments, certain steps can be performed in a different order, in parallel with one another, omitted entirely, and/or combined between different exemplary methods, and/or certain additional steps can be performed, without departing from the scope and spirit of the invention. Accordingly, such alternative embodiments are included in the invention described herein.

The invention can comprise a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention.

The invention can be used with computer hardware and software that performs the methods and processing functions described above. Specifically, in describing the functions, methods, and/or steps that the airline can perform in accordance with the invention, the airline can accomplish any or all of these steps by using an automated or computerized process. As will be appreciated by those skilled in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the invention defined in the following claims, the scope of which is to be accorded the broadest interpretation so as to encompass such modifications and equivalent structures.

What is claimed is:

1. A non-transitory computer-readable medium having computer-readable program code embodied therein for providing establishment recommendations to a requesting consumer having a ratings history, the computer-readable program code comprising:
computer-readable instructions for receiving through an automated process a ratings history from a plurality of consumers; and
computer-readable instructions for providing at least one of an establishment recommendation and an item recommendation to the requesting consumer based on the ratings history of the requesting consumer and the ratings history of similar consumers,
wherein similar consumers comprise consumers in the plurality of consumers having a similar ratings history to the ratings history of the requesting consumer.

2. The non-transitory computer-readable medium of claim 1, wherein a ratings history of a consumer comprises an establishment patronized by the consumer.

3. The non-transitory computer-readable medium of claim 2, wherein the ratings history further comprises an item ordered by the consumer at the establishment.

4. The non-transitory computer-readable medium of claim 1, wherein a ratings history of a consumer comprises a rating received from the consumer, the rating being associated with at least one of an establishment patronized by the consumer and an item ordered by the consumer at an establishment.

5. The non-transitory computer-readable medium of claim 1, wherein the automated process comprises at least one of:
performing optical character recognition on an image of a receipt identifying an establishment patronized by a consumer;
receiving an indication of a location of a consumer from a location module of a mobile device associated with the consumer;
receiving an indication of an establishment patronized by a consumer from a financial institution involved in paying the establishment; and
receiving an electronic copy of a receipt provided by an establishment.

6. The non-transitory computer-readable medium of claim 1, wherein the automated process comprises the steps of:
receiving an image of a receipt identifying an establishment patronized by a consumer; and
performing optical character recognition on the image of the receipt to yield a receipt text.

7. The non-transitory computer-readable medium of claim 6, wherein the automated process further comprises the steps of:
identifying the establishment patronized by the consumer in the receipt text;
identifying an item ordered by the consumer in the receipt text; and
storing the establishment and item in a ratings history associated with the consumer.

8. The non-transitory computer-readable medium of claim 1, wherein an establishment recommendation is provided to the requesting consumer.

9. The non-transitory computer-readable medium of claim 1, wherein an item recommendation is provided to the requesting consumer.

10. The non-transitory computer-readable medium of claim 1, wherein an establishment recommendation and an item recommendation are provided to the requesting consumer.

11. The non-transitory computer-readable medium of claim 1, wherein the at least one of the establishment recommendation and the item recommendation is provided in response to a request for a recommendation from the requesting consumer.

12. The non-transitory computer-readable medium of claim 1, wherein the at least one of the establishment recommendation and the item recommendation is provided in response to a determination that the requesting consumer is within a given distance from the establishment recommended.

13. A non-transitory computer-readable medium having computer-readable program code embodied therein for receiving ratings data from a consumer, the computer-readable program code comprising:
computer-readable instructions for receiving through an automated process ratings data from the consumer;
computer-readable instructions for identifying an establishment in the ratings data; and
computer-readable instructions for associating the establishment with the consumer.

14. The non-transitory computer-readable medium of claim 13, wherein the computer-readable instructions for receiving through an automated process ratings data from the consumer comprises:
computer-readable instructions for receiving an image of a receipt identifying an establishment patronized by the consumer; and
computer-readable instructions for performing optical character recognition on the image of the receipt to yield a receipt text.

15. The non-transitory computer-readable medium of claim 14, wherein the image is received from a mobile device of the consumer.

16. The non-transitory computer-readable medium of claim 14, wherein the receipt text comprises an establishment name and at least one item name.

17. The non-transitory computer-readable medium of claim 16, wherein the receipt text further comprises a price associated with each item name, and wherein the computer-readable program code further comprises:
computer-readable instructions for receiving a correlation of item names with members of a dining party of the consumer;
computer-readable instructions for calculating a total amount owed by each member of the dining party based on the correlation and the price associated with each item name; and
computer-readable instructions for indicating to the consumer the total amount owed by each member of the dining party.

18. The non-transitory computer-readable medium of claim 13, wherein the computer-readable instructions for receiving through an automated process ratings data from the consumer comprises computer-readable instructions for using a location module associated with the consumer to identify an establishment patronized by the consumer.

19. A system for providing establishment recommendations to a requesting consumer having a ratings history comprising:
an OCR module for performing optical character recognition on images of receipts received from a plurality of consumers and identifying ratings data associated with each consumer in the plurality of consumers;
a database for storing a ratings history associated with each consumer, the ratings history comprising the identified ratings data associated with each consumer; and
a similarity module in communication with the database for identifying similar consumers in the plurality of consumers,
wherein similar consumers comprise consumers in the plurality of consumers having a similar ratings history to the ratings history of the requesting consumer.

20. The system of claim 19, further comprising a location module associated with a consumer in the plurality of consumers for identifying a location of the consumer in the plurality of consumers.
